(19) United States
(12) Patent Application Publication
(10) Pub. No.: US 2013/0191260 A1
(43) Pub. Date: Jul. 25, 2013

(54) SYSTEM AND METHOD FOR RECORDING DATA ABOUT QUANTITIES OF ENERGY AND EVALUATING SAID DATA

(71) Applicant: Matthias Michael, Berlin (DE)

(72) Inventor: Matthias Michael, Berlin (DE)

(21) Appl. No.: 13/825,887

(22) PCT Filed: Sep. 25, 2010
(86) PCT No.: PCT/DE2010/001138

§ 371 Date: Mar. 25, 2013

(51) Int. Cl. G06Q 30/04

(52) U.S. Cl. CPC G06Q 30/04
USPC 705/34; 700/291; 700/83

(57) ABSTRACT

With the present invention, a system and a method is presented, which is capable of automatically clearing relevant data on primary energy amounts or produced quantities of energy, such as heat continuously at a custom unit (7) receive and the data to a central server (3) for supplying, by means of a specific program, the complete handling of the contractual agreement between a management company and a consumer (2) performs. The result of the customer-specific evaluation of the recorded data supplied and serves on the one hand of the full implementation of the agreements and transmission custom calculations, and the automatic switching on and off the supply of primary energy, when limits are exceeded.

The present invention relates to a system and method for recording data of energy quantities and their automatic analysis, especially with the automatic analysis of thermal energy quantities of consumers who have entered into a contract with a management company (Contractors).

Such systems are known from GB 2455965 A. This system reveals the delivery and settlement of consumer goods, such as electricity and gas. The known system is based on the idea that paying consuming energy in agreement with the respective utility companies in advance. The coordination between customers and utility companies is taken up by conventional data transmission such as GPRS or UMTS or via mobile phones from a local station and carried out. The recorded data is through a transfer unit (modem) supplied by the customer to a database, which is only the influence of the respective utility company.

Furthermore, in the prior art power remote meter reading systems have become known in which meter data automatically via the Internet and will be charged subsequently queried according to specific criteria. Then the results of the settlement will be sent to the customer. The system is mainly used by utility companies for customers who want a certain transparency of their respective consumption.

Further is in the prior art provides a software, which is able to crosslink globally dispersed systems or machines by radio to a central server by means of an IP protocol, with high safety and quality standards.

Which recorded the date in the prior art known processes for the automatic evaluation data together adherent disadvantages are commonly seen in:
Isolated applications of data collectors (concentrator) based on proprietary radio systems or standardized open systems.
Data from radiators to a data collector, which can then be read on local radio by passing cars. The measured data are unfortunately not used to optimize and reduce energy consumption.
Business processes based on the data is not possible in real time.
On the retail side has the consequence that heating systems are regulated primarily by the outside temperature.
Thus, the provision of the amount of heat is too high and inefficient.
Due to interior sensors, heat consumption is indeed accurately recorded, but an efficient operation is currently not by the insularity and pure consumption measurement.
Other systems available today mainly for the industrial sector, and aim only at the remote diagnostics, troubleshooting and configuration. The terms used in this field modules and sensors are heterogeneous and essentially have a rule with proprietary communication protocols (868 MHz).

The aim of the present invention is to provide the energy to make information from all areas and from all individual units of a consumer can be evaluated, which has a number of advantages for customers.

It is therefore an object of the present invention to provide a system with a method that is capable of performing an Internet-based platform for the organization and management (management) of existing contracts and a remote service.

This object is achieved with the characterizing features of the main claims.

According to the invention, the system for the automatic recording of amounts of energy at at least one consumer with at least one server and at least one database and at least one energy unit is (heating), characterized by at least one at the customer installed electronic custom unit, and at least one means (data modem), the wireless transmitting data, the system comprising at least one switching device which is capable of at least the energy consumption unit on and off.

The electronic customer-specific unit has to be used to simplify the data collection and allow a largely configuration-free detection of existing sensors. Heating systems can be equipped with remote maintenance systems and sensors and upgraded. Also further sensors are addressed independently of the heating system. The collection and transmission of sensor data to storage on a server is based on the customer-specific unit (Adunos Box GPRS/UMTS).

Through the use of open interfaces, the new data collector (concentrator) provide for transparency in the communication with the other local systems. Existing standards such as BACnet, LON, ZigBee, C-Net or wirless M-Bus support with the concentrator and allow vendor-independent data collection.

The collected data is fed to the central server of the management company, historically evaluated and processed for the user. The management system identifies trends and influences and controls e.g. the effective delivery of heat. Periods of low heat demand can thus be recognized locally and considered locally. The platform (Adunos) thus enables responsive and efficient and localized delivery of heat. The intelligence of this concentrator is on the server.

The resulting processes are not restricted to the area of heat. They can be applied to other areas such as electricity, water, etc. transferred. This will reduce costs and contribute to environmental sustainability.

An intelligent control and the opening of the business processes for contracting for heat toward the end user is only possible because of the Concentrator. The consumptions are in the platform (Adunos) stored in real time and used for settlement of amounts of heat. The concentrator is the basis for the realization of the proposed optimization processes. A similar integrated module, which by use of open communication protocols implemented to collect data in the building and has a certain server intelligence does not exist currently.

This box can be integrated into standard systems continue praying for SMART metering.

The essential advantages of the present invention are:
Greater transparency
More individual ways of energy management and energy conservation
Improved customer service for retail customers of the contracting
Improved connectivity, integrated networking
Low costs through “one fits all” solution

An advantageous aspect of the invention is further described in the introduction of energy-efficient heat generators, heat transparency of transactions and simplify business processes (heat meter on the Internet) and, not least, the savings in energy and CO2.

In particular, the automation module (Adunos box) is used for data transfer from the heating system to a central server and back.
A concentrator, which collects data from the entire building information and than sending it using the Automation Module (Adunos box) to the server, is a useful extension to play the retail-side benefits.
the developed web-based platform for the management of contracts and contracting the remote service, especially for geothermal heat pumps play as contracting their superiority in energy efficiency compared to conventional heating system based on fossil fuels.

The concentrator module realize the following features:
Integration of a concentrator module in the automation module (box)
A concentrator collects data from different data producers (sensors);
They are used to capture data for later processing in the CAFM (Computer Aided Facility Management);
The Concentrator is integrated unlike conventional data loggers in the Adunos automation module provides interfaces and forth to different systems;
Integration with the Adunos box leads to the possibility that the data collected in real-time transfer to a server, where to use them in business processes, eg, based on ZigBee and/or wireless M-bus, ZigBee an open wireless network standard. PHY and MAC layer based on IEEE 802.15.4, which enables home appliances, sensors, and much more connects over short distances (10 to 100 meters). The standard was developed by the ZigBee Alliance;
Bi-directional data flow: Radiators→Concentrator→Adunos Box→Central Server→End User.

In all this, it is advantageous that the aggregate energy consumption is a heater that can be powered by any form of primary energy, in particular electricity, gas, oil, coal or wood.

Another advantage is that the database in the central server of the system includes customer-specific data, on which a program stored in the central server has access to prepare custom measures and execute, and create records of results.

It is also advantageous that the customer-specific data are adjusted in accordance with the utility companies, which are among other clients of the system.

It is also advantageous that the customer-specific data, particularly data of the consumption of primary energy and power generated quantities, such as amounts of heat, the end user include.

Another advantage is the fact that a quantity of heat scoring unit is provided, which is preferably installed in the supply line of the primary energy to the energy consumption unit (heater) and parameters relating to receiving amount of heat flow temperature, return temperature and current gas volume flows.

It is also advantageous that the heating unit receives at least one heat pump module.

It is also advantageous in that the wireless data transmission is carried out for example by GMS, GPRS, UMTS.

Furthermore, it is advantageous that a user interface is provided for example on the basis of PHP, which is determined on the one hand for the end user and the other for an employee of the electricity supply company and only those persons have access to their respective user interfaces.

It is advantageous, moreover, that all the relevant data will be collected for the billing method and stored in a so-called log and at intervals, such as ten minutes, and can be recorded at predetermined time intervals, for example, every four hours, to be sent to the central server, wherein the time intervals can be chosen freely.

It is furthermore advantageous that at least one so-called user protocol is provided which accesses the results in the database of the central server.

The inventive method for automatically recording and billing of amounts of thermal energy in a system having at least one heat generating unit and at least one heat-counting unit and at least one central server with at least one database, characterized by the following process steps:
Inclusion of customer-specific data contract customers in the database of the central server;
Installation of a heat quantity counting custom unit to at least one heat generating unit;
Wireless transmission of recorded data to the central server of the system;
Accessing the data stored in the customer-specific data structured database using at least one program, which is stored in the central server;
Access using the program to the data stored in the database and data analysis;
And store the results of the evaluation, and
Initiation of action based on the results, and
Access to the results in the database for at least one protocol.

An object of the present invention is to fulfill the contract between the management company (ADUNOS) and the customer automatically on the basis of the collected data.

Another aspect of the present invention is the Internet-based open settlement platform for the management of bond contracts (contracting) and remote maintenance of small-scale systems, in particular geothermal heat pumps. Simplified it can be said that the heat meter to be placed on the Internet. The settlement on the internet platform is offered as a service and can be used by any number of contractors and other customers. Contractors are therefore monitored through a web portal capable of remotely operating their systems, billing perform to detect faults and possibly fix from afar, to improve customer service by recognizing problems and potential use errors and the turns off customers and problems with the payment of invoices implements effective shutdown actions. The customers of the contractors can monitor via an Internet portal their own energy consumption and consciously implement meaningful energy conservation, e.g. to reduce the operation costs.

The products can be expanded as remote maintenance system for service providers such as artisans with maintenance contracts, as well as standard heating systems, as well as a platform for the management of heat supply by property managers. An switch on of consumers who want to use it to control their investment and want to achieve energy savings, is also possible.

Overall objective of the present invention is to provide the technical basis for a fully automated processing of contracting to provide an environmentally friendly use of available resources.

Geo thermally powered heat pumps (shallow geothermal) allow a reduction of the heating energy by up to 80%. These heat pumps thus replace the conventional heat generators that use gas or oil. Several studies have shown that by contracting as a way of financing the installation together with the heat supply of the market for this environmentally friendly technology would be significantly increased, as many potential customers shy away from an immediate, relatively high initial investment. By contracting clients include a heat supply contract with the Contractor. The investment takes the Contractor. Sporadically present in the practical application has also been the so-called plant contracting, which can certainly be seen as a form of equipment leasing, could be handled by the platform. In the field of heat pumps, as well as the conventional heat generator for apartments and houses, there is no technical solution that makes an online collection and processing of the consumed amounts of heat possible.

Contracting is in most cases only been used for large energy users in industry and government. Contracting Activities for young plants are inter alia so difficult to implement, as a comprehensive facility management as larger objects is not possible. The settlement of the energy consumed is difficult because there is no automated billing and Remote maintenance options. Mostly there are already solutions for utility bills that run automated.

The aim of this partial aspect is therefore for geothermal heat pumps and supplied to other heat sources that internet-based platform (ADUNOS) for heat collection and processing of other data provide. Contracting providers are added at this platform as a service of the relevant management company in a position to detect the heat consumption of the heat pump with their customers in real time and to settle. Energy customers of the contracting party are influenced over the Internet in a position on the basis of historical and technical data of energy consumption and control their own energy consumption.

Based on historical data control interventions are possible. Through the conscious active control of the energy consumption of the customer about the Contracting portal, the customer is able to adapt its own energy consumption to current or long-term needs. The central data management makes a precise energy demand analysis easier. It helps indirectly to optimize energy terms also small customers, which in turn lowers your costs, energy consumption and CO2 emissions. Linking different data provides detailed statements about energy consumption. At the customer gets through the portal, the data as raw or processed and any links with daily e-mail or using an individual interface ERP systems.

Interfaces to the billing systems of the contractors and the users are set up. Even large systems will be connected in the future. The solution must have the following characteristics (specification):
Detection of heat consumption
Acquisition of the power consumption
Billing of energy consumption
Online access to the power plant by Contractor and Customer
Customer Portal for the inspection of the energy consumption and self-introduction of energy conservation measures on the system (transparency and return channel)
Opportunities for cost optimization
Process optimization, reducing the administrative burden
Possibility of contracting of small heat sources (single family, etc.)
Fault Management
Efficiency of the optimal control system
Storage of historical data for statistics and derive an intelligent process control system
Controlling energy supply and energy production (load-based and efficiency)
Possibility of remote shut down payment interruptions
Flexible representation of other parts of the contract
Figure fixed and flexible price components
Management and preventive maintenance inspection
Remote access via the Internet Troubleshooting
Remote Support
Visualization of the Internet
Integration of various control systems of heat pumps as well as other energy systems (solar, oil, gas, pellets, biomass, biogas, roof, etc.) in combination with the heat pump
Data Collection
Lower maintenance costs
Identifying and resolving user errors on the telephone customer service or directly via the Internet on energy investment

Additional inventive features are described in the dependent claims and the description.

In what follows, the invention will be described with reference to drawings in detail below.

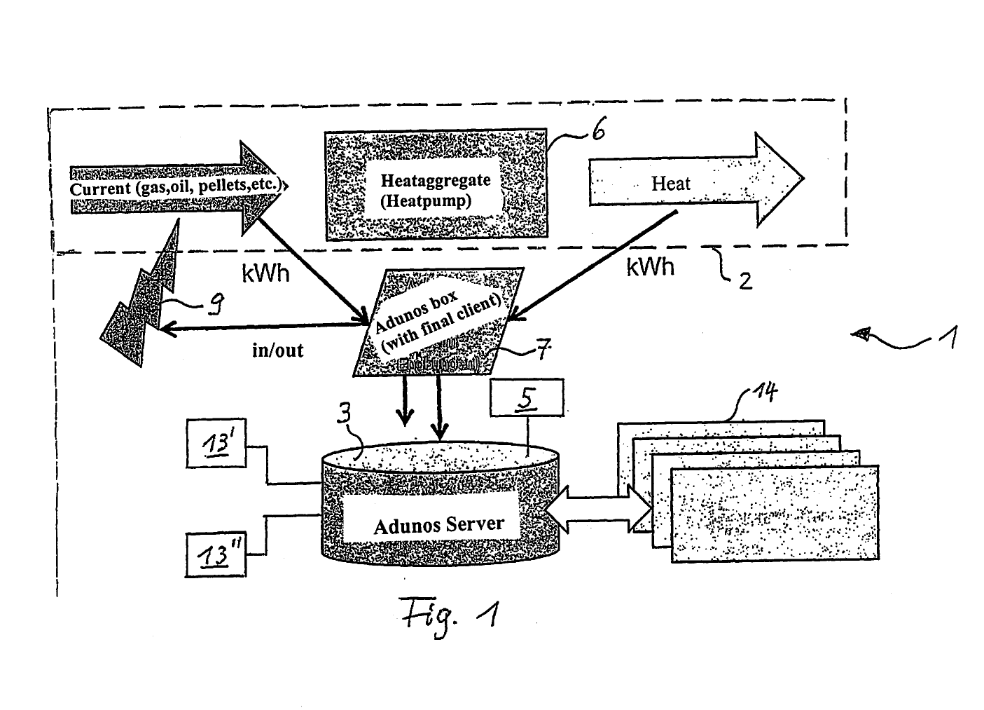

FIG. 1: shows the architecture of the system (1) with its main components;

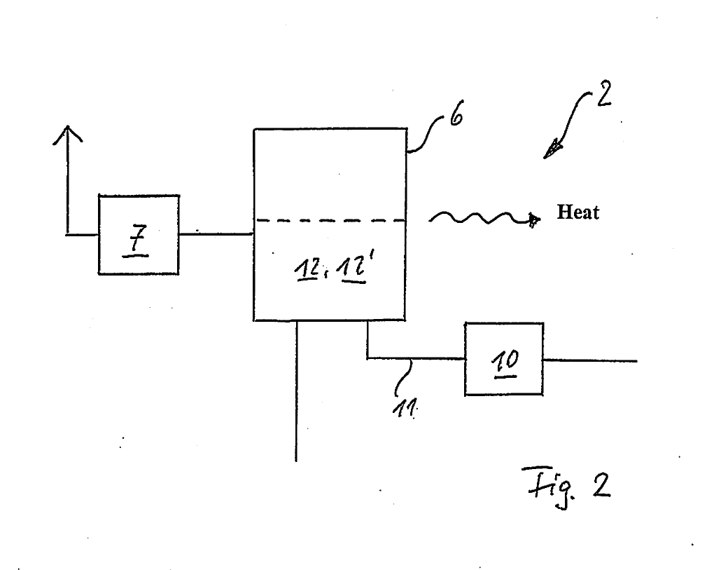

FIG. 2: shows a schematic block diagram of a portion of the system to generate heat at an end user (2);

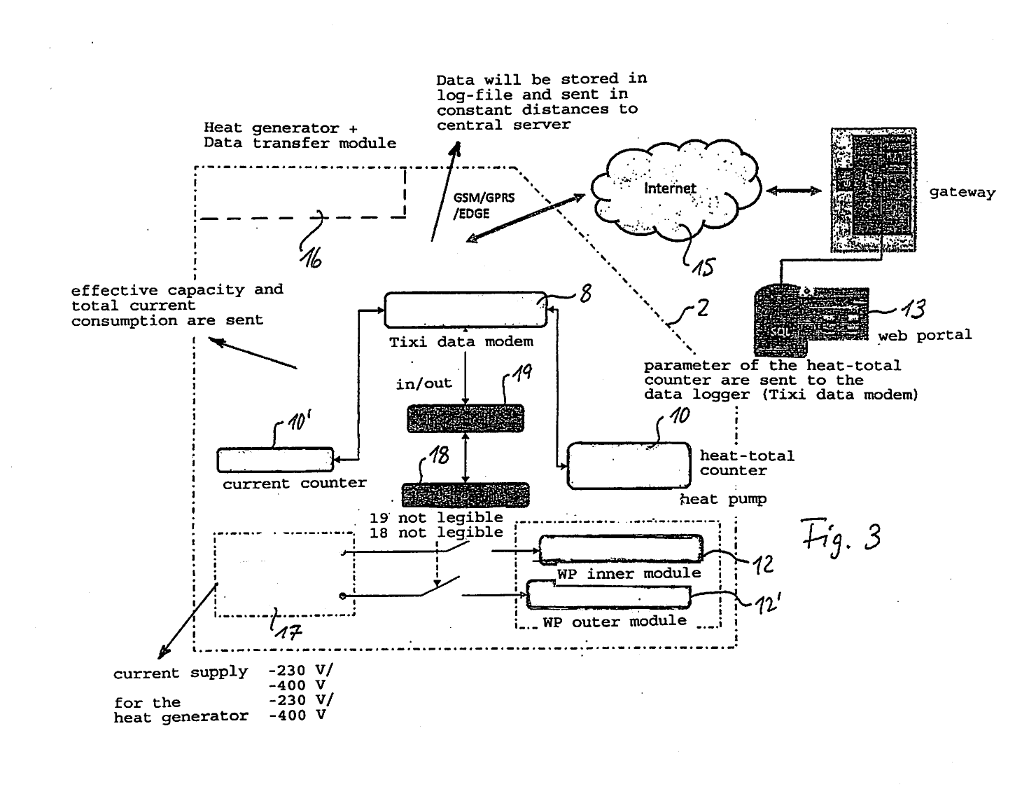

FIG. 3: shows a schematic block diagram of the customer-specific unit (7) in cooperation with the peripheral units (12, 12′, 16) and the connection to a wireless telecommunications network (15) (the Internet);

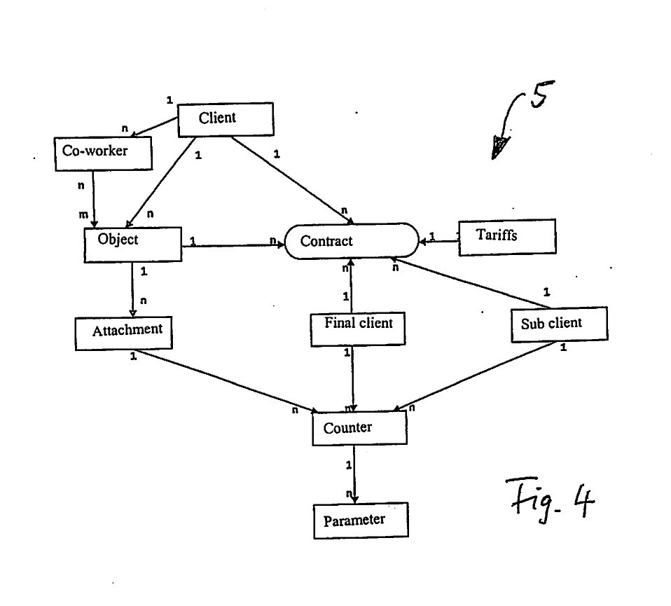

FIG. 4: shows a block diagram of the structure (Scheme) of the database (5) in the central-server (3) of the system (1);

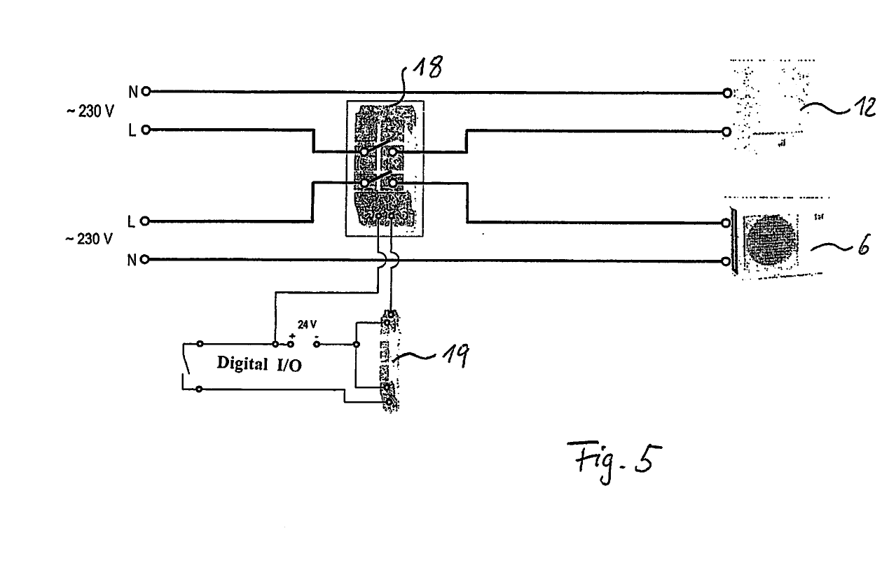

FIG. 5: shows a schematic representation of the switching unit (9).

The FIG. l shows the architecture of the system 1 in the form of a block diagram, are contained in the essential features of the present invention. System 1 consists essentially of the parties, such as the consumer 2, who runs at least a heater 6 and the management company (ADUNOS), the heating unit 6, which houses one hand, primary energy such as gas, oil, electricity, pellets etc. and the primary energy into heat, and thus at least one heated room of the end user the 2nd The absorbed energy and the primary amount of heat generated is absorbed by a heat quantity counting unit 10. The recorded data, including not only the primary energy and the amount of heat emitted with data on the flow temperature, return temperature, the current gas flow, are then fed into a customized unit 7, the property management company (ADUNOS) and installed at the end user 2. The recorded data on the current consumption and the heat generated amounts to a central server 3 is fed by wireless remote transmission, the associates and stores this data in a structured database 5. This database 5 is explained in more detail below and includes in addition to the consumption data and custom data from contractors 14th The system 1 includes at least two portals with two user interfaces 13, 13′, at least one user interface 13 for the end user 2 and at least one user interface for the employees 13′ of the respective utility company or the management company (ADUNOS) is determined, and only that person access has to the corresponding user interface. Based on the data collected at specific time intervals a so- called IP protocol is created for the result and with the switching unit can be operated 9 that at least the supply of primary energy can be switched on and off. This switch unit 9 is in a simple embodiment of an electro-mechanical contactor for the power supply of the heat generating unit and the heat pump.

The FIG. 2 shows a schematic block diagram of the units of the system 1, which are installed at the end user second Primary energy is determined by the supply line 11 supplied to the heating unit 6, which generates the required amount of heat to heat the rooms. The data of the amount of heat generated are recorded in the heating unit 6, and the customer-specific electronic unit 7 is supplied. The custom unit 7 is explained below in more detail. The amount of data recorded in the custom unit 7 is combined into an IP protocol and in arbitrary time intervals, such as every ten minutes transmitted wirelessly via a modem via radio to the central server 3. In the supply line 11, a counting unit 10 is incorporated, which measures the supply of primary energy, and provides data relating to the volume of gas flow, the flow temperature, the return temperature and the amount of heat generated.

The FIG. 3 shows a schematic block diagram of the interaction between the customer-specific unit 7, the heat pump modules 12, 12′ and the data transmission module 16 In this illustration, the engineering units that are installed at the end user 2 represented. Raised through the heating unit 6 and the two heat pump modules 12, 12′ for the interior and the exterior with the counting unit 10 data for determination of the amounts of heat are supplied to a data logger 8, which stores the data in a log file and at constant intervals to the central server 3 sent. The transfer of the data stored in the log file is sent in a data module 16 via GSM/GPRS/EDGE transmit via the Internet or on other means of transmission by radio to the central server 3. In addition, the custom unit 7 includes nor a count of the primary energy sources such as electricity, gas, oil, coal, or wood pellets, which also feeds data to the data modem 8 and data transmission module 16 at predetermined time intervals. The power supply 17 for the heat source is removed from the normal 220/380 volt power-house of the end user the 2nd The power supply is connected via a contactor 18 to the heater 6th The contactor 18 is actuated by a switching relay 19, which in turn receives its switching states from the data modem eighth. The switch states (on/off) are the result of the evaluation of the recorded consumption data and the user interface 13, 13′ input individual consumer data. The result from the consumption data and other custom retail data is thus directed to the requirements that are placed by the management company or the power company in Central Server 3 Management Company (ADUNOS).

The FIG. 4 shows a general overview of the structure and schema of the database 5, on which the central server 3 has access. The database 5 includes mainly the data of the agreement between the management company and the client, such as a power company and the object (end user) that is to be supplied with primary energy. In addition, this contract data are relative to the corresponding energy tariffs, which have been agreed with the customer or a sub-client available online. In addition, the database contains all the data, which were recorded by customer's heat quantity counter unit 7. In this database 5 a program has immediate access to, which as a result of both an invoice and switching states of the unit 7, or the switching unit 9 generates.

The FIG. 5 shows a schematic representation of the switching unit 9. Here, the 230 V power line is a contactor 18, both on a heater 6 as well as at least one heat pump module 12, which together heat the room to be heated. The contactor 18 is connected to a coupling unit 19 low-voltage side (24 V). The coupling unit 19 includes a digital I/O, which receives its signals from the server 3. Is the result of calculations based on the data recorded negative, ie, the operation of the plant is not appropriate, receives the I/O signal to open the contactor 19, whereby the supply of primary energy for the end user is interrupted.

The inventive system 1 provides an online platform for the settlement of amounts of heat to the target group contractors for small systems for heat supply, especially geothermal powered heat pumps represent a similar solution is not available on the market. In the System 1 is a total solution to heat meter to bring the Internet with the ability to extend to virtual building management of small objects in a cloud computing, making access for smaller heat source possible. Besides contractors can also artisans and other service providers use around heat sources such an open platform for the management of their maintenance contracts with customers in the single or multi-family houses, apartments, etc. Furthermore, the solution can be used in property management companies to manage across all heating systems (virtual building management). The platform (ADUNOS) thus provides an infrastructure for billing, maintenance, and energy conservation conscious.

By the way, the important information from the data of the measurement points in real-time online opportunity to read and planned improvements in the control system to make—can significantly increase the savings for both small and large installations.

This problem is solved with a mobile machine-to-machine communication over the Internet, both to fetch the required data from the pumps in the set up database and secondly, a portal infrastructure, which allows data to visualize on portals and data in customer systems, e.g. Billing systems in contractors to carry.

Furthermore, commands the client to be implemented directly in the heat pump on site. To address the particular requirements of the following technical facilities should be provided:
Two-way Machine-to-machine (M2M) communication independent of the telephone network and DSL, as experience shows that the link lead to any existing phone lines often result in error messages or as for failure to pay the bill over the phone and can not be accessed. A solution using a VPN can the automation modules fixed IP addresses are assigned and are also always achieved by the control center.
Central data storage for all incoming machine data.
Minimal traffic to keep the hardware requirements low, and keep the cost of monthly data transfer over UMTS low.
The Automation Module will stay permanently while logged on the net (always-on), but only transmit data on demand.
The heat pump system must be achieved through a standardized interface, we favor here Modbus, which works over serial and Ethernet interface.
The automation software module is adapted to the different heat pump controller via the Modbus communication protocol. To a programmable embedded system based on Linux and Java is provided with integrated web server. Continue to be embedded UMTS/GSM module. The unit can be monitored from a distance, parameterized and may be updated with new firmware. The device must be integrated in this way in an inventory management system.
Simple, automated and standardized data transfer of data from the database in the accounting systems of the contractor. These are usually integrated ERP system. Standard interfaces via XML should be configurable.
Control Commands from the ERP system must (eg final warning) arrive as temporary shutdown in the heat pump system. Unique identifier for the control controller is necessary for it.
Tenancy at several levels: B2B customers (contractors, service companies, etc.) and B2C customers (end users of B2B customers).
Billing is via the application server as a service, especially for smaller contractors.
Visualization of the heat pump and the basic control mechanisms in an end-user portal on the Internet in order to promote transparency about the conscious energy savings.
An add-on of this solution is the related possibility to integrate the heat pump in a virtual building management and to offer service providers for Home Services and remote maintenance.
“Management by exception” when alarms are triggered, critical operating conditions, etc. for maintenance or repair. These alarms are triggered by excess and shortfall of limit values to be permanently controlled, dependent on the structural conditions of the heat pump, such as:
Minimum and maximum temperature limit
Building time constant
Pressure in the heating system
Switch-on and switch-off
Hot water temperature
Set temperatures and run temperatures
Supply of electric energy
Flow
Deviations from the curve

The approach can be summarized briefly as follows:

The solution is the creation of an internet database in which the operating data of the heat pump customers are stored. The client, the contractor, takes the respective heat consumption data over the Internet and created his bills. Alternatively be placed on the web server applications for billing and inventory management for the contractor are available:
Connection to external systems via Modbus
Wireless connection of devices for collecting data and for controlling ZigBee and/or wireless M-Bus
Interface: RS232, RS485, CAN bus, LIN bus, RJ45
Own CPU with embedded Linux or Java and Web server for remote configuration and inventory management
Own CPU for data processing and for any control and regulation tasks
Tightly integrated universal inputs and outputs
Integrated hardware clock with date and time, adjustable via Internet
DIN rail
Temperature: +5 to +40° C.
Relative humidity: 5% to 85%
According to common standards DIN EN 50178/VDE 0160 for automation equipment
Class II
UMTS/GSM module, integrated over Ethernet
Automatic hardware reset
Configuration via the GPRS network via integrated web server
Supports VPN for integration into an internal network access via the server
Own CPU with embedded Linux or Java and Web server for remote configuration and inventory management
Own CPU for data processing and for any control and regulation tasks
Tightly integrated universal inputs and outputs
Integrated hardware clock with date and time, adjustable via Internet
DIN rail
Temperature: +5 to +40° C.
Relative humidity: 5% to 85%
According to common standards DIN EN 50178NDE 0160 for automation equipment
Class II
UMTS/GSM module, integrated over Ethernet
Automatic hardware reset
Configuration via the GPRS network via integrated web server
Supports VPN for integration into an internal network access via the server.

The customers receive a personalized web access to the application server. This requires basic functions such as unique identification via SSL-login and transfer of the data. In addition to the user interface to man a machine-to-machine communication is set up for the contractors to transfer data directly from the database into the ERP systems of the customers.

1. System (1) for the automatic recording of amounts of energy at at least one end user (2) and at least one party (14), which provides the energy available and at least one server (3) and at least a database (5), which contains data the counting of at least a heat unit (10) are added, and at least one heat-generating unit (6), characterized by at least one customer-specific unit (7) at an end user (2), the at least one means (8) includes (for example, a data modem) the wirelessly received data to the server (3) transfers and the system (1) at least one switching device (9) includes, which is at least capable of the heating unit (6) on and off.

2. A system according to claim 1, characterized in that the heating unit (6) are fed by primary energy with each shape may, in particular electricity, gas, oil, coal, or wood.

3. System according to claim 1, characterized in that the database (5) in the server (3) of the system (1) customer-specific data includes (eg from Consumer (2) used amounts of heat), to the one in the server (3) program stored has access to create custom measures.

4. System according to claim 1, characterized in that the customer-specific data are matched in accordance with the respective power supply companies (4).

5. System according to claim 1, characterized in that the customer-specific data, in particular data of the consumption of heat quantities of the end user include (2).

6. System according to claim 1, characterized in that at least an amount of heat scoring unit (10), which is preferably in the power supply line (11) installed for heating unit (6) and receiving parameters relating to the amount of heat, the flow temperature, the reflux temperature, the actual gas flow.

7. System according to claim 1, characterized in that the heating unit (6) at least one heat pump module (12, 12′) can be switched on, which contributes to the heating/cooling of the rooms to be air conditioned.

8. System according to claim 1, characterized in that the wireless data transmission is carried out for example by GMS, GPRS, UMTS or ZigBee or wireless M-Bus.

9. System according to claim 1, characterized by at least one user interface (13, 13′), for example on the basis of PHP, a user interface (13′) for the end user (2) and a user interface (13″) for employees of the electricity company (4) is determined.

10. Method for the automated recording and billing of energy levels (for example, heat quantities) in a system (1) counted by at least one heat-generating unit (6), a thermal unit (10) and at least one server (3) with at least one database (5), the data are fed from a customer-specific unit (7), characterized by the following process steps:
Inclusion of customer-specific data contract customers (14);
Installation of a heat quantity counting unit (10) at least one heat-generating unit (6) of the end users;
Wireless transmission of recorded data to the server (3) of the system (1);
Supply of the recorded data from the heat-generating unit (6) and a customer-specific unit (7) to the central server (3);
Access means of a program that is stored in the database, customer-specific data and analysis of the automatically captured data;
And store the results of the evaluation, and
Access to the results in the database of at least one portal (13, 13′), and
Initiation of action (e.g. pressing the switch unit (9) based on the results.

11. Method according to claim 10, characterized in that all relevant data are collected for the billing method and stored in a log file, and are recorded at intervals of between 5 minutes to hourly, preferably every 10 minutes, and every four hours to the central server is sent (3), wherein the intervals are freely selectable.

12. Method according to claim 10, characterized in that at least one user interface (13, 13′) have access to the results in the database of the server.
